(19) United States
(12) Patent Application Publication
(10) Pub. No.: US 2025/0292938 A1
(43) Pub. Date: Sep. 18, 2025

(54) RAPID DUMP OF SUPERCONDUCTOR MAGNETS

(71) Applicant: Tokamak Energy Ltd, Oxfordshire (GB)

(72) Inventors: Jeroen van Nugteren, Oxfordshire (GB); Ivan Krastev, Oxfordshire (GB)

(21) Appl. No.: 18/862,304

(22) PCT Filed: May 3, 2023
(86) PCT No.: PCT/EP2023/061703

§ 371 Date: Nov. 1, 2024

(30) Foreign Application Priority Data
May 3, 2022 (GB) 2206445.5

(51) Int. Cl. H01F 6/02; H01F 6/06

(52) U.S. Cl. CPC H01F 6/02; H01F 6/06

(57) ABSTRACT

A superconductor magnet system including a field coil assembly including two or more coil sections connected in series. Each coil section has a plurality of turns including superconductor material. The turns in each coil section are connected by an electrically conductive material such that electric current can be shared between the turns. The system further includes a magnet heating system including a plurality of voltage sources. Each of the voltage sources is connected across a respective one of the coil sections of the field coil assembly to apply a voltage having an AC component and/or a DC component across the coil section to drive current through the electrically conductive material. The voltage sources are configured such that at least two of the voltages have AC components that are out of phase and/or DC components that have opposing polarities.

### CROSS-REFERENCE TO RELATED APPLICATIONS

This application is the U.S. National Stage entry of International Application No. PCT/EP2023/061703, filed on May 3, 2023, which, in turn, claims priority to United Kingdom Patent Application No. GB 202206445, filed on May 3, 2022, all of which is hereby incorporated herein by reference in its entirety for all purposes.

### FIELD OF THE INVENTION

The present invention relates to superconductor magnets, particularly high temperature superconducting, HTS, magnets. In particular, the invention relates to a method for rapidly heating superconductor magnets, e.g. in response to quench detection, and systems implementing the method.

### BACKGROUND

Superconducting materials are typically divided into “high temperature superconductors”

(HTS) and “low temperature superconductors” (LTS). LTS materials, such as Nb and NbTi, are metals or metal alloys whose superconductivity can be described by BCS theory. All low temperature superconductors have a peak critical temperature (the temperature above which the material cannot be superconducting, even in zero magnetic field) below 30 K. The behaviour of HTS materials is not described by BCS theory, and many have critical temperatures well above 30 K. The most commonly used HTS materials are “cuprate superconductors”—ceramics based on cuprates (compounds containing a copper oxide group), such as BSCCO, or ReBCO (where Re is a rare earth element, commonly Y or Gd). Other HTS materials include iron pnictides (e.g. FeAs and FeSe) and magnesium diboride (MgB₂).

ReBCO superconductors are typically manufactured as tapes approximately 100 micrometres thick and with a width of between 2 mm and 12 mm. The structure of a typical tape 100 is illustrated in FIG. 1 and includes a substrate 101 (typically an electropolished nickel-molybdenum alloy, e.g Hastelloy™ approximately 50 micrometres thick), on which is deposited a series of buffer layers known as the buffer stack 102, of approximate thickness 0.2 micrometres. An epitaxial ReBCO-HTS layer 103 overlays the buffer stack, and is typically 1 micrometre thick. A 1-2 micrometre silver layer 104 and a copper stabilizer layer 105 are deposited on and often completely encapsulate the tape. The silver layer 104 and copper stabilizer layer 105 extend continuously around the perimeter of the tape 100 (not illustrated in FIG. 1 for clarity) and may therefore also be referred to as “cladding”. The silver layer 104 makes a low resistivity electrical interface to, and an hermetic protective seal around, the ReBCO layer 103, whilst the copper layer 105 enables external connections to be made to the tape (e.g. by soldering) from either face and provides a parallel conductive path for electrical stabilization. “Exfoliated” HTS tape can also be manufactured, which lacks a substrate and buffer stack.

HTS tapes and other superconducting materials may be characterised by a critical surface of a maximum current, temperature and magnetic field at which the superconductor transitions from a superconducting state to a normal state. For example, the critical current, I_{c}, is the current at which the superconductor becomes normal at a given temperature and magnetic field, and the critical temperature, T_{c}, is the temperature at which the superconductor becomes normal for a given magnetic field and current. Critical temperature is often formally defined for zero magnetic field, but the term is used more generally herein for convenience. The critical surface of many HTS tapes can also be highly dependent on both the magnitude and direction of a magnetic field.

An HTS cable comprises one or more HTS tapes, which are connected along their length via conductive material, normally copper. Under this definition, a single HTS tape is an HTS cable. The HTS tapes may be stacked (i.e. arranged such that the HTS layers are parallel), or they may have some other arrangement of tapes, which may vary along the length of the cable.

A superconducting magnet is formed by arranging HTS cables into coils comprising one or more turns. A turn (or winding) of a coil is a section of HTS cable which encloses the inside of the coil (i.e. which can be modelled as a complete loop). Broadly speaking, there are two types of construction for magnetic coils—by winding, or by assembling several sections. Wound coils, as shown in FIG. 2, are manufactured by wrapping an HTS cable 201 around a former 202 in a continuous spiral. The former is shaped to provide the required inner perimeter of the coil, and may be a structural part of the final wound coil, or may be removed after winding. Sectional coils, as shown schematically in FIG. 3, are composed of several sections 301, each of which may contain several cables or preformed busbars 311 and will form an arc (i.e., a continuous section that is less than a whole turn) of the overall coil. The sections are connected by joints 302 to form the complete coil. Coils or coil sections will often be consolidated by encapsulating or potting them, and the encapsulating material may fill spaces between the turns. Suitable encapsulation materials include both insulating materials such as epoxies and conductive materials such as solders.

FIG. 4 shows a cross section of a specific type of wound coil known as a “pancake coil”, where HTS cables 401 are wound in a planar spiral to form a flat coil. Pancake coils may be made with an inner perimeter which is any 2-dimensional shape. Often, pancake coils are provided as a “double pancake coil”, as shown in the cross section of FIG. 5. These comprise two pancake coils 501, 502 wound in opposite sense with insulation 503 between them. The inner terminals are connected 504. This means that a voltage only needs to be supplied to the outer terminals 521, 522, which are generally more accessible, to drive current through the turns of the coil and generate a magnetic field. Many other coil configurations are possible, including helical solenoids.

One use of HTS field coils is in tokamak plasma chambers, including spherical tokamaks, where strong magnetic fields are required to confine and control plasma. Another potential use of HTS field coils is in proton beam therapy (PBT) and proton boron capture therapy (PBCT) devices in which beams of protons are used in the treatment of cancers. PBT and PBCT devices require very high magnetic fields to both accelerate and steer the proton beams.

HTS coils come in three broad classes:
Insulated, having electrically insulating material between and separating the turns. In this arrangement, current can flow only around the turns of the coil (i.e., in a spiral path along the HTS cables).
Non-insulated, where the turns are connected with a low resistance, e.g. by a conductive metal. This can be achieved, for example, by forming the coil such that the copper stabilizer layer (or other metal cladding) connects the turns and/or the coil is potted with a conductive solder.
Partially insulated, where turns are connected with a resistance intermediate between a conductor and an insulator. This may be achieved by separating the turns with a material having a high resistance compared to copper (e.g., a co-wound stainless steel tape or any layer with a desired resistance), and/or by providing intermittent insulation between the turns, and/or by providing resistive material (which may comprise components such as resistors) along the side of a coil and connecting at least some of the turns. The resistance between turns in a partially insulated coil may be controlled between 100 and 10¹⁵ times that of copper to achieve a desired ratio, L/R, between the inductance, L, around the coil and the resistance, R, across it. Different forms of partial insulation are described in WO2019150123 and WO2020079412 as just some examples.

Non-insulated coils can be considered as the low-resistance case of partially insulated coils. In general, in both partially insulated and non-insulated pancake coils, the turns are connected by a normally (i.e., non-superconducting) conductive material or, equivalently, a resistive (but not insulating) material such that electric current can be shared between the turns via the conductive material. For example, in pancake coils current can flow radially as well as around the spiral path. In a solenoid, an additional longitudinal current path is provided.

A non-insulated or partially-insulated HTS coil can be modelled as having three current paths-two spiral paths, which follow the HTS cables around the turns (one in the HTS and one in the metal stabilizer), and a turn-to-turn path across the magnet, between coil terminals. In a pancake coil, for example, this turn-to-turn path will be a radial path through the metal stabilizer and any other resistive material connecting the turns. While this can be modelled as a single path, it in fact represents the sum of all resistive paths across the magnet. Only current flowing in the spiral paths generates a significant magnetic field. The HTS spiral path can be modelled as an inductor having a large inductance and zero or negligible resistance when the tape is all superconducting. The stabilizer spiral path is in parallel with the HTS spiral path and has the same inductance (in a simple model), but significant resistance. For this reason, negligible current flows in it unless parts of the HTS spiral path start to quench. The turn-to-turn path across the magnet can be modelled as having a negligible inductance and a much greater resistance than the HTS spiral path while the HTS material is superconducting.

Negligible current flows in this path unless parts of the HTS spiral path start to quench or the current in the HTS spiral path is changed (due to the large inductance of HTS spiral path opposing a change in current). If the HTS spiral path starts to quench, excess current above the critical current I_{c} of the HTS spiral path shares between the spiral stabilizer path and the turn-to-turn path according to their relative resistances and L/R time constants.

HTS field coils are generally designed to operate with all the HTS tapes in all turns running at less than their local critical current, I_{c}, which varies around the coil due to variations in the magnetic field and coil temperature. However, various fault conditions can cause HTS tape currents to exceed the critical current:
Cooling failure, increasing the temperature (locally or globally) and thereby reducing I_{c}.
Transient increase in transport current, I₀, e.g. a power supply over-current fault.
Damage to the HTS material (for example, due to stress cracking, fatigue from thermal cycling or energization cycling of the magnet).
Localized energy deposition that is sufficient to cause a thermal runaway.

If the current in any tape exceeds (or nears) the local critical current, some of the current will be driven into the metal layers of the tape (principally the copper stabilizer layer), into any other normally conductive (i.e., not superconducting) material separating the turns in a non-insulated or partially insulated coil and into any “spare” I_{c} capacity of nearby HTS material. Current flowing through normally conductive material generates heat and reduces the local critical current I_{c} further, potentially leading to thermal runaway.

The region of the HTS tape initially affected by a fault condition is known as a “hotspot”. Early detection of hotspots is important so that damage to the HTS magnet can be avoided by “quenching” the magnet and dissipating its energy. Various approaches to detecting hotspots are known, e.g. using temperature sensors, strain sensors or voltage taps distributed around the magnet. Large HTS magnets are able to store huge amounts of magnetic energy, which needs to be dissipated safely and rapidly in the event of a quench.

WO2020/104807 describes a method of ramping down or quenching a non-insulated or partially insulated HTS magnet in which a large “reverse” current is applied to the magnet, i.e. in the opposite direction to the current flowing through the HTS coils of the magnet prior to the ramp-down. This reverse current flows primarily in the radial path, causing significant heating of the magnet and quenching it rapidly.

### SUMMARY

According to a first aspect of the present disclosure there is provided, a superconductor magnet system comprising a field coil assembly comprising two or more coil sections connected in series. Each coil section has a plurality of turns comprising superconductor material. The turns in each coil section are connected by electrically conductive material such that electric current can be shared between turns (i.e., electric current can flow between the connected turns via the conductive material). The system further comprises a magnet heating system comprising a plurality of voltage sources. Each of the voltage sources is connected across a respective one of the coil sections of the field coil assembly to apply a voltage having an AC component and/or a DC component across the coil section to drive current through the electrically conductive material. The voltage sources are configured such that at least two of the voltages have AC components that are out of phase and/or DC components that have opposing polarities.

Resistive heating of the electrically conductive material generates heat, which raises the temperature of the superconductor material, preferably to temperatures above a critical temperature of the superconductor material to cause a loss of superconductivity therein.

By configuring the voltage sources such that at least two of the voltages have AC components that are out of phase and/or DC components that have opposing polarities, current may be driven through the electrically conductive material without it being necessary to apply large voltages across the field coil assembly as a whole. For example, by applying out of phase AC voltages across the coil sections, the instantaneous voltages that are applied across the field coil assembly as a whole may be minimised. Preferably, the instantaneous voltages applied across the coil sections may be (substantially) equal and opposite such that the voltage applied across the field coil assembly as a whole is approximately zero (or within a predetermined tolerance). Thus, an advantage of using multiple voltage sources (as compared to a single voltage source) to heat the coil is that the voltages over the superconductor magnet can be limited to lower levels, which reduces risk of voltage-induced breakdowns, which may damage the field coils and/or leads supplying current to the field coils, for example. As the voltage sources drive current through the electrically conductive material, rather than around the turns of superconductor material, the magnet heating system can also be operated independently from the power supply providing current to the superconductor magnet. For example, the operating current from the magnet heating system (which may typically be part of a quench protection system) does not require the transport current in the superconductor magnet to be above a certain level in order for the heating to be effective.

The conductive material is in thermal contact with the superconductor material. One arrangement, which provides particularly good thermal contact, is where the conductive material comprises an electrically conductive layer separating the turns. Another arrangement is to provide the conductive material alongside the coil.

The voltage sources may be configured such that a phasor sum of the voltages applied across the coil sections has an amplitude less than an amplitude of at least one of the alternating voltages applied to the coil sections, or preferably less than an amplitude of all of the alternating voltages applied across the coil sections. A phasor sum refers here to a sum of phasors (i.e. phase vectors), each phasor being a complex number representation of one of the voltages.

The voltage sources may be configured such that respective amplitudes of the voltages applied across to the coil sections differ by less than 10%, preferably less than 5%, or more preferably less than 1% of the largest of the amplitudes. Where the voltage sources comprise respective AC components, the frequencies of the AC components are preferably substantially the same (e.g. the frequencies differ by less than 10%, preferably less than 5%, or more preferably less than 1% of the largest of the frequencies).

Each voltage source may comprise a capacitor or bank of capacitors. Each of the voltage sources may comprise a respective switch, preferably a thyristor, for connecting and/or disconnecting the voltage source from its respective one of the coil sections.

The field coil assembly may comprise a single field coil or multiple field coils connected in series. In the case of multiple field coils, each coil section may be confined to a single field coil or span two or more of the field coils. Each field coil may be a pancake coil having a respective axis about which the turns are wound, the turns being nested radially one inside the other with respect to the axis.

The magnet heating system may comprise a transformer having at least one primary coil for inducing respective AC voltages across two or more secondary coils of the transformer simultaneously, each of the voltage sources comprising at least one of the secondary coils connected across the corresponding coil section. The transformer is preferably configured such that the AC voltages applied across the coil sections are out of phase.

The transformer may be a single-phase transformer. Preferably, the transformer is configured such that the AC voltages applied across the coil sections by two of the secondary coils are out of phase by 180 degrees.

The transformer may be a 3-phase transformer comprising three primary coils. The three primary coils are preferably arranged in a delta configuration. The primary and secondary coils may form a balanced three-phase system.

Each primary coil may be configured to induce respective AC voltages in at least two of the secondary coils.

The superconductor magnet system may further comprise a cryostat for cooling the superconductor magnet to temperatures below a critical temperature of the superconductor material. The secondary coils, and optionally the primary coils, of the transformer may be provided within the cryostat.

The superconductor material may be high temperature superconductor (HTS) material, such as ReBCO, or low temperature superconductor (LTS) material.

Each of the coil sections includes a respective number of turns. The numbers of turns being may be equal to within 10%, preferably 5% or more preferably 1% of a largest of the numbers of turns.

The field coil assembly may comprise multiple field coils connected in series, each coil section being provided by a respective one or more of the field coils. Each coil section preferably comprises the same number of field coils. Alternatively, the field coil assembly may comprise a single field coil, such that each coil section includes a subset of the turns of the field coil. Each coil section preferably has the same resistance.

The superconductor magnet system may further comprise one or more further field coil assemblies. Each further field coil assembly comprises two or more coil sections connected in series, each coil section having a plurality of turns comprising superconductor material. The magnet heating system may comprise a respective plurality of voltage sources for each of the further field coil assemblies. Each of the voltage sources is connected across a respective one of the coil sections of the further field coil assembly to apply a voltage having an AC component and/or a DC component across the coil section to drive current through the electrically conductive material. The voltage sources are configured such that at least two of the voltages have AC components that are out of phase and/or DC components that have opposing polarities. The applied voltages may differ between some or all of the field coil assemblies, e.g. to achieve different heating rates for each of field coil assembly.

According to a second aspect of the present disclosure there is provided a tokamak comprising one or more superconductor magnet systems according to the first aspect. The field coil assembly of each of the superconductor magnet systems may comprise a toroidal field coil or poloidal field coil of the tokamak.

According to a third aspect of the present disclosure there is provided a proton beam therapy, PBT, device comprising one or more superconductor magnet systems according to the first aspect. The field coil assembly of each of the superconductor magnet systems may comprise: a field coil of an accelerator of the PBT device or a field coil of a dipole or quadrupole magnet of a proton beam steering system of the PBT device.

According to a fourth aspect of the present disclosure, there is provided a method of heating a superconductor magnet. The superconductor magnet comprises a field coil assembly comprising two or more coil sections connected in series. Each coil section has a plurality of turns comprising superconductor material. The turns in each coil section are connected by an electrically conductive material such that electric current can be shared between the turns. The method comprises applying a respective voltage having an AC component and/or a DC component across each of the coil sections to drive current through the electrically conductive material. This causes heating of the superconductor material of the respective coil section. At least two of the voltages have AC components that are out of phase and/or DC components that have opposing polarities.

The voltages may be applied across the coil sections in response to detecting a quench or conditions likely to cause a quench in one or more of the coil sections.

At least one of an amplitude, frequency and waveform of one or more of the voltages may be adapted to heat the superconductor material in the one or more coil sections from a first equilibrium temperature to a second equilibrium temperature greater than the first equilibrium temperature and less than a critical temperature of the superconductor material. This may allow, for example, a critical current of the superconductor material to be decreased such that a ratio of transport current to critical current in the superconductor material is increased when a DC electric current is supplied to the field coil assembly. Screening currents in the superconductor material may thereby be diminished or eliminated.

Applying a respective voltage having an AC component and/or a DC component across each of the coil sections to drive current through the electrically conductive material may comprise: applying an AC voltage to at least one primary coil of a transformer to induce respective AC voltages across two or more secondary coils of the transformer simultaneously; and applying each of the AC voltages across a respective one of the coil sections, wherein the AC voltages applied across the coil sections are out of phase.

The method may further comprise connecting a power supply across the superconductor magnet to cause electric current to flow through the superconductor material to generate a magnetic field, the power supply remaining connected across the superconductor magnet after applying the respective voltages across each of coil sections, at least until the temperature of some or all of the superconductor material in the coil section exceeds a critical temperature of the superconductor material.

According to a fifth aspect of the present disclosure, there is provided a superconductor magnet system comprising: a field coil assembly comprising two or more coil sections connected in series, each coil section having a plurality of turns comprising superconductor material; and a magnet heating system comprising a transformer having at least one primary coil for inducing respective alternating voltages across two or more secondary coils of the transformer simultaneously. Each of the secondary coils is connected across a respective one of the coil sections of the field coil assembly to apply the corresponding alternating voltage across the coil section. The transformer is configured such that the alternating voltages applied across the coil sections are out of phase.

Embodiments of the fifth aspect may include the features indicated above as being optional features of the first aspect. For example, the transformer may be a 3-phase transformer comprising three primary coils. The three primary coils are preferably arranged in a delta configuration. The primary and secondary coils may form a balanced three-phase system.

According to a sixth aspect of the present disclosure, there is provided a method of heating a superconductor magnet. The superconductor magnet comprises a field coil assembly comprising two or more coil sections connected in series. The method comprises: applying an alternating voltage to a primary coil of a transformer to induce respective alternating voltages across two or more secondary coils of the transformer simultaneously; and applying each of the alternating voltages across a respective one of the coil sections. The alternating voltages applied across the coil sections are out of phase.

Embodiments of the sixth aspect may include the features indicated above as being optional features of the fourth aspect. For example, the voltages may be applied across the coil sections in response to detecting a quench or conditions likely to cause a quench in one or more of the coil sections.

According to a seventh aspect of the present disclosure there is provided a superconductor magnet system comprising: a magnet assembly comprising two or more coil sections connected in series, each coil section having a plurality of turns comprising superconductor material; an alternative current path across each coil section, the alternative current path comprising resistive material and having a low inductance compared to the respective coil section such that a changing current across the coil section preferentially flows through the alternative current path, wherein heating of the resistive material caused by current flowing through the alternative current path causes heating of the superconductor material of the respective coil section; and a plurality of voltage sources, each of the voltage sources being connected across a respective one of the coil sections and its alternative current path to apply a voltage having an AC component and/or a DC component, the voltage sources being configured such that at least two of the voltages have AC components that are out of phase and/or DC components that have opposing polarities.

Optional and preferred features of the seventh aspect will be apparent from the foregoing discussion of other aspects.

### BRIEF DESCRIPTION OF THE DRAWINGS

FIG. 1 is a schematic representation of an HTS tape;

FIG. 2 is a schematic representation of a wound HTS coil;

FIG. 3 is a schematic representation of a sectional HTS coil;

FIG. 4 is a cross section of a pancake coil;

FIG. 5 is a cross section of a double pancake coil;

FIG. 6 is a circuit diagram of an HTS magnet system;

FIGS. 7A and 7B are graphs showing simulated voltages for the HTS magnet system of FIG. 6;

FIG. 8 is a circuit diagram of an HTS magnet system;

FIGS. 9A and 9B are graphs showing simulated voltages for the HTS magnet system of FIG. 8;

FIGS. 10 is a circuit diagram of an HTS magnet system;

FIG. 11 is a circuit diagram of an implementation of part of the HTS magnet system of FIG. 10;

FIGS. 12 is a circuit diagram of an HTS magnet system; and

FIG. 13 is a circuit diagram of an implementation of part of the HTS magnet system of FIG. 12.

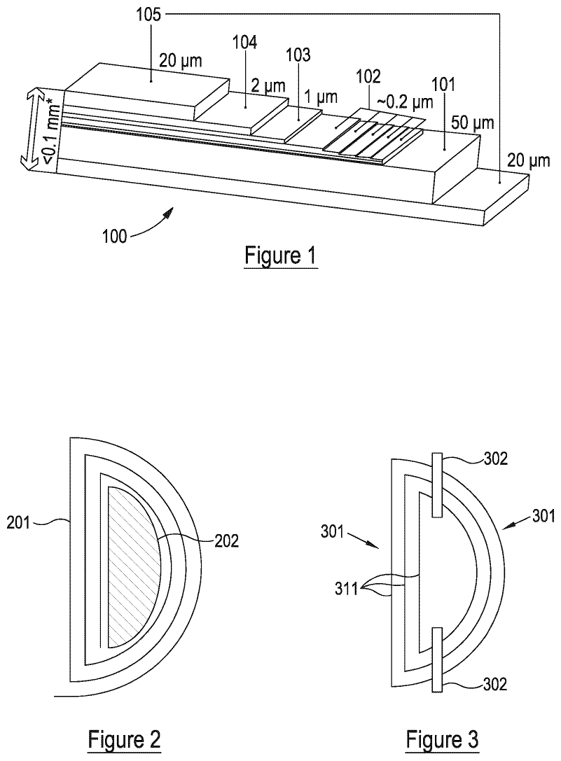

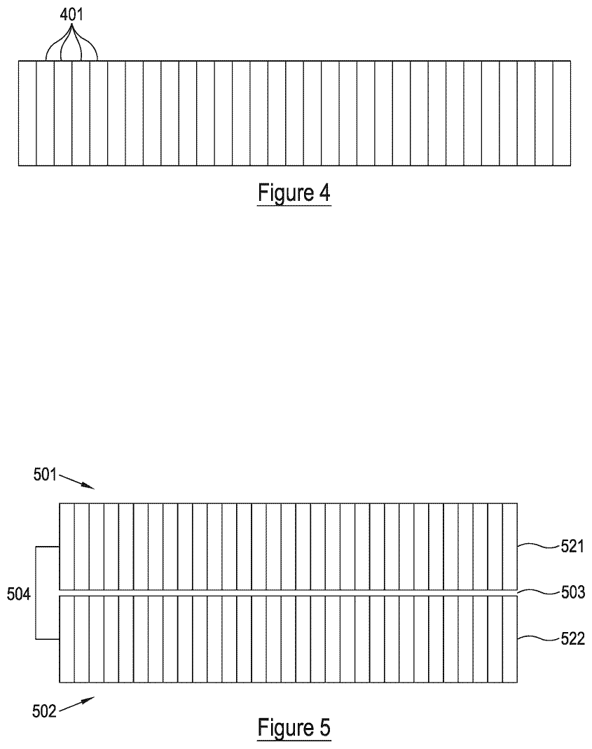

### DETAILED DESCRIPTION

The present disclosure provides methods and systems for rapidly heating a superconductor (e.g. HTS) magnet so that the energy stored in the magnet can be safely dissipated. The superconductor magnet may, for example, comprise a plurality of field coils which require rapid simultaneous heating so that each of the field coils is quenched at the same time.

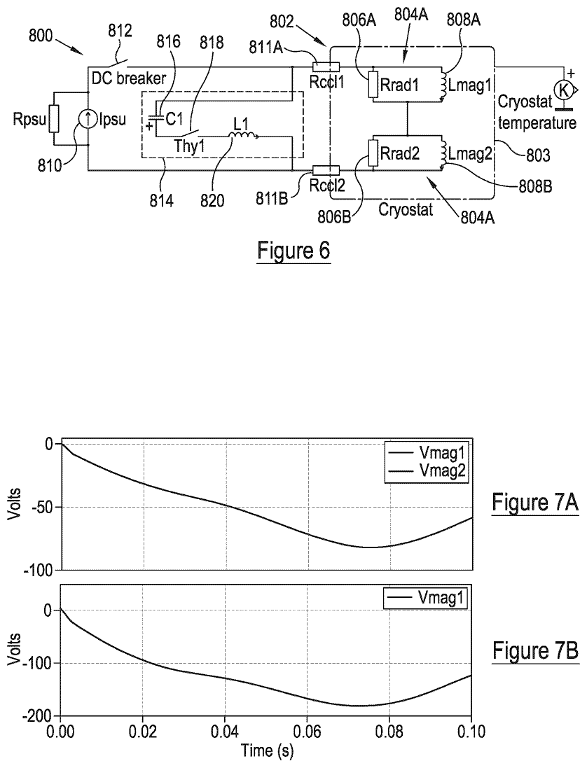

To illustrate an existing system for ramping down a superconductor magnet, FIG. 6 shows an HTS magnet system 800 that includes an HTS magnet 802 provided inside a cryostat 803 for cooling the HTS magnet 802 such that it is able to maintain a superconducting current for generating a magnetic field. The HTS magnet 802 comprises a partially insulated HTS field coil comprising a first coil section 804A and a second coil section 804B connected in series with one another. In the below description of this existing system and of the present invention, the coils are assumed to be planar, spirally wound coils (i.e., pancake coils) with partial insulation provided by a conductive layer separating the turns. This is purely for ease of illustration. It will be recognised that the techniques described below can be applied to many non-insulated and partially insulated coil constructions, including those discussed in the background introduction, and that the below is just one, non-limiting example.

Each of the coil sections 804A, 804B is represented in FIG. 6 by a radial resistance 806A, 806B connected in parallel with an inductor 808A, 808B. In general, each turn of a field coil may be represented by a radial resistance and an inductor connected in parallel, i.e. the field coil may be represented by a number of coil sections equal to the number of turns, each coil section comprising a radial resistance connected in parallel with an inductance. A coil section may therefore comprise a single turn or multiple turns. “Partially insulated” means that the turns of the coil are electrically connected by conductive material such that electric current can flow radially between the turns. For example, the partially insulated coil may comprise an insulating layer provided between the turns of HTS material, with one or more conductive paths extending through the insulating layer. A magnet power supply 810 is connected across the HTS magnet 802 to supply DC electric current to the HTS magnet 802 via first and second leads 811A, 811B. A circuit breaker 812 is also provided in series with the magnet power supply 810 to allow the power supply 810 to be rapidly disconnected from the HTS magnet 802 in the event of a hotspot forming or beginning to form in the HTS magnet 802 (or other conditions that might lead to a quench being initiated).

The HTS magnet system 800 also includes a magnet heating system 814 connected in parallel with the magnet power supply 810 across the HTS magnet 802 and comprising a voltage source 816 (which may also be referred to as a power supply) having a polarity that is opposite to that of the magnet power supply 810 in order to supply a “reverse” current to the HTS magnet 802. In this example, the voltage source 816 comprises a pre-charged capacitor. The magnet heating system also comprises a thyristor 818 (although another type of switch could be used), which is used to connect or disconnect the capacitor from the HTS magnet 802, and a current limiting inductor 820, which controls the peak current that is supplied to the HTS magnet 802 and hence the peak terminal voltage across the magnet 802 (i.e. across the current leads 811A, 811B). The peak current may alternatively (or additionally) be controlled by adjusting the radial resistance, e.g. by varying the resistance of the conductive material provided between the turns. The inductor 820 is preferably tuned to achieve the lowest peak current that is needed to raise the temperature of the HTS magnet 802 by the desired amount (e.g. from around 20 K to around 40 K, the critical or “transition” temperature of the HTS material) within the desired time. The time needed for safe discharge depends strongly on the current density in the coil. For a large tokamak, operating at 100 A/mm² with added stabilizer, the time may be on the order of seconds, while for small coil running at 600 A/mm², the time may be around 100 ms.

During “normal” operation of the HTS magnet 802, the circuit breaker 812 is closed and the thyristor 818 is open, thereby allowing the magnet power supply 810 to supply current to the HTS magnet 802, whilst the capacitor 816 is disconnected from the HTS magnet 802. The circuit breaker 812 may comprise a diode preventing current from the capacitor 816 from entering the magnet power supply 810. When ramp-down of the magnet current is required, the circuit breaker 812 is opened and the thyristor 818 is closed, such that current is no longer supplied to the HTS magnet 802 from the power supply 810 and a reverse current begins to flow from the capacitor 816 of the magnet heating system 814 to the HTS magnet 802. As the superconducting spiral path of the magnet 802 has a large inductance, the reverse current flows primarily through the radial resistances 806A, 806B of the first and second coil sections 804A, 804B (rather than through the inductors 808A, 808B), thereby heating the coil sections 804A, 804B. The radial resistances 806A, 806B (provided by the conductive material between the turns) are integrated in the field coil and are therefore in good thermal contact with the turns. The energy stored in the magnet is dissipated over a large area when the magnet quenches, rather than in only one of the coil sections or particular turns, for example. Compared to other coil heating methods that rely on coupling losses between the turns to heat the superconductor material, resistive heating caused by current driven through the conductive layer allows more control over where the heating occurs. In addition, once the superconductor material becomes normal, the very large current flowing through it is diverted through the conductive layer to heat other parts of the field coil very rapidly.

FIGS. 7A and 7B show how the voltages across each of the coil sections 804A, 804B (FIG. 7A) and across the HTS magnet 802 as a whole (FIG. 7B) vary as a function of time (in seconds) after the thyristor 818 is switched to discharge the capacitor 816. The initial voltage of the capacitor 816 in this example is around 800 V and is discharged by around 30 ms after the thyristor 818 is switched. The discharge therefore has two distinct phases—a capacitor discharge phase (up to ˜30 ms) and an inductor discharge phase (from around 30 ms to around 100 ms). During the capacitor discharge phase, energy is dissipated into the circuit resistances, but is also transferred to the magnetic field of the current limiting inductor 820. The voltage across each of the coil sections 804A, 804B decreases as the capacitor discharges, decreasing from 0 V to around −50 V at 40 ms, and then undergoes an oscillation from −50 V to −80 V and back to −50 V in the next 70 ms or so. As the coil sections 804A, 804B are equivalent in this example (which is why only a single curve is visible on the graph shown in FIG. 7A), the voltage across the HTS magnet 802 as a whole is twice the voltage of across each of the coil sections 804A, 804B individually.

During the capacitor discharge phase, the magnitude of the (reverse) radial current flowing in each of the coil sections 804A, 804B increases to around 50 kA and then decreases gradually over the period in which the inductor discharges. This current heats the coil sections 804A, 804B to raise the temperature of the HTS material, in this case from 20 K to around 70 K, so that it ceases to be superconductive.

A diode (not shown) may be connected across the capacitor 816 to avoid the capacitor voltage reversing, which may cause damage to the capacitor 816. When the capacitor voltage reaches 0 V, the diode starts conducting and the discharge is then a function of the L/R time constant of the system, which provides a more efficient method for dissipating the capacitor energy. The diode is not essential, however, and the circuit can be allowed to ring at the natural LC frequency instead.

The magnet heating system 814 is generally straightforward to implement and can be tuned to give the necessary performance in terms of discharge time. A capacitor 816 having the necessary characteristics may be provided in the form of a bank of capacitors connected in parallel with one another (for example). However, the high-current circuit breaker 812 may in some cases be hard to obtain or implement, and may therefore need to be purpose-built. The “large” voltage (e.g. around 200 V, which may be considered large in the context of the very high, e.g. kA, currents that typically flow within the coil) across the HTS magnet 802 when using the magnet heating system 814 may also be a significant disadvantage in some cases.

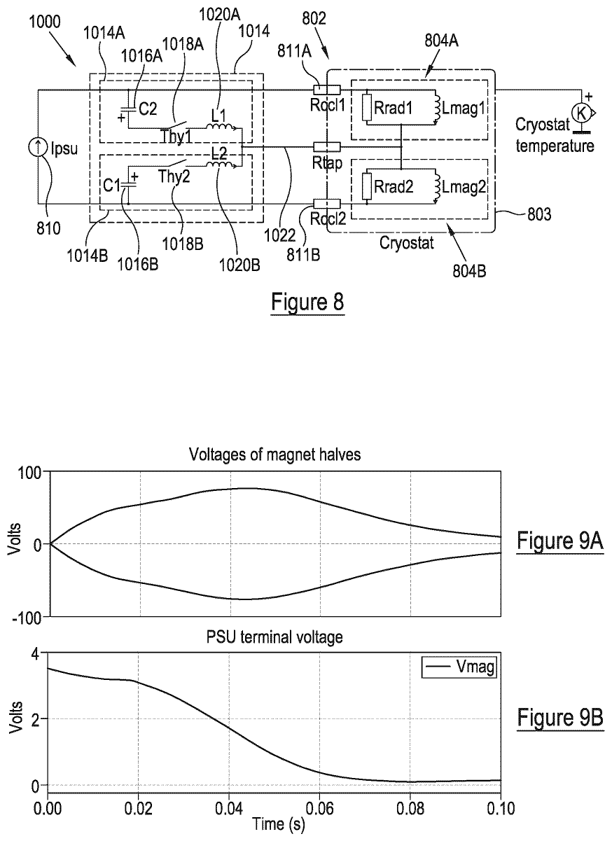

FIG. 8 shows an HTS magnet system 1000 that is similar to the HTS magnet system 800 of FIG. 6, except that the magnet heating system 1014 comprises two DC voltage sources 1014A, 1014B, one for each of the first and second coil sections 804A, and the HTS magnet system 1000 does not include a DC circuit breaker 812 (because, as noted below, the voltage across the HTS magnet 802 is much lower than for the HTS magnet system 800 of FIG. 6), although a DC circuit breaker 812 could be included if desired. A first of the two voltage sources 1014A is connected across the first coil section 804A via one of the current leads 811A (i.e. to a terminal of the first coil section 804A to which the magnet power supply 810 is also connected) and a second connection to a magnet “tap” (current lead) 1022 between the first and second coil sections 804A, 804B. A second of the two voltage sources 1014B is connected across the second coil section 804B via the magnet tap 1022 and the other current lead 811B (i.e. to a terminal of the second coil section 804B to which the power supply 810 is also connected). The DC voltage sources 1014A, 1014B are configured to have opposite polarities to one another. Each of the voltage sources 1014A, 1014B comprises a respective capacitor 1016A, 1016B that is switched by a respective thyristor 1018A, 1018B. In this case, each of the voltage sources 1014A, 1014B also has a respective inductor 1020A, 1020B to limit the peak current, as described above.

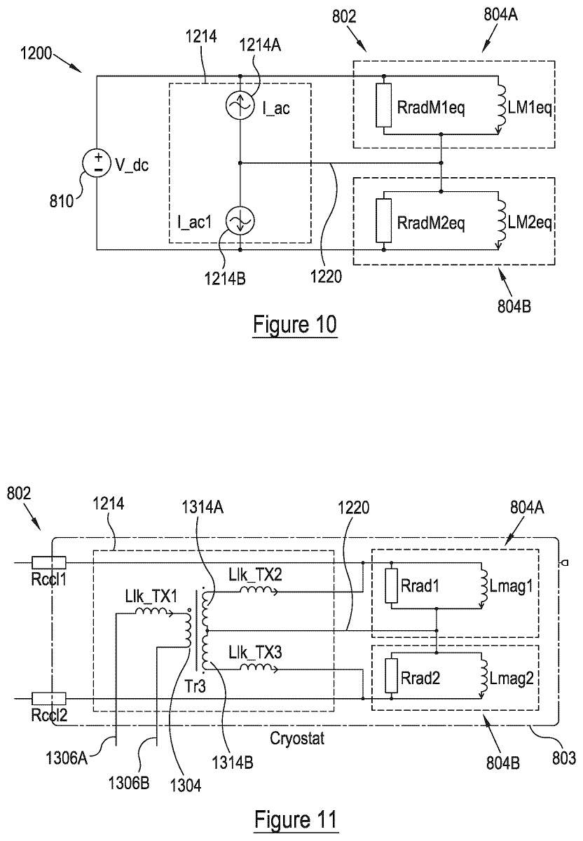

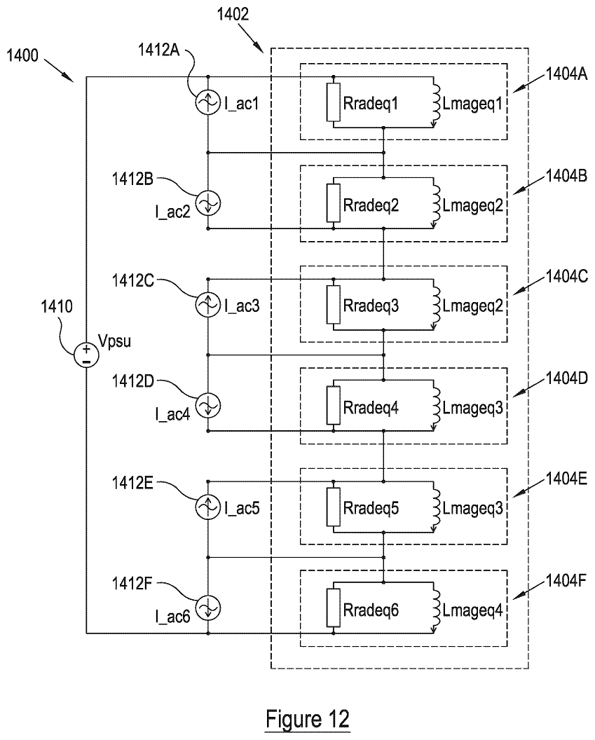

FIGS. 9A and 9B show how the voltages across each of the coil sections 804A, 804B (FIG. 9A) and across the HTS magnet 802 as a whole (FIG. 9B) vary as a function of time after the thyristors 1018A, 1018B are switched to discharge the capacitors 1016A, 1016B. As the voltages applied across the first and second coil sections 804A, 804B by the capacitors 1016A, 1016B are in this case equal and opposite at all times (although there may be small differences due to variations in radial resistance, differences in inductance of leads and the quality of the layers etc.), their contributions to the voltage across the HTS magnet 802 cancel one another. The total voltage across the HTS magnet 802 therefore remains low, in this case less than 4 V, throughout the discharge. This low voltage may mean that the power supply 810 does not need to be disconnected from the HTS magnet 802 during the discharge. A circuit breaker 812 may not therefore be required, for example. It should be noted, however, that the voltage on the magnet tap 1022 increases during the discharge. When the capacitors 1016A, 1016B are discharged, the current flows through the magnet tap 1022 and radially through the first and second coil sections 804A, 804B in opposite directions. The net DC current measured at each of the terminals of the HTS magnet 802 (i.e. at the current leads 811A, 811B) therefore remains approximately constant during the discharge, e.g. at around 7 kA for in the present example.

Although the examples described above have referred to single capacitors 816, 1016A, 1016B, each of the capacitors may be provided in the form of a bank of capacitors, which may be connected in parallel with one another, for example. The capacitors may be metal film oil-filled capacitors or so-called “supercapacitors”. Other types of voltage source may also be used instead of or in addition to capacitors, such as batteries (e.g. lithium polymer batteries), superconducting magnetic energy storage (SMES) or flywheel energy storage.

Similarly, although the magnet system 1000 has been exemplified by an HTS magnet 802 comprising two coil sections 804A, 804B, any number of coil sections 804A, 804B connected in series may be used. More generally, the magnet may comprise a field coil assembly, which may have more than one field coil connected in series. In this case, the coil sections may comprise a subset of the turns in a single coil or all the turns in a single coil, or even turns from more than one coil. For example, a tokamak may in some cases comprise 14 toroidal field coils connected in series and the magnet tap 1022 may then be provided between the 7^{th} and the 8^{th} toroidal field coils, such that the coils sections 804A, 80B each comprise 7 field coils, and the capacitors 1016A, 1016B therefore supply electric current in opposite directions through toroidal field coils 1-7 and 8-14. Preferably, the number of HTS coils is even, such that the magnet tap 1022 can be provided at a midpoint of the HTS magnet to ensure equal current flow on either side of the magnet tap 1022.

A potential drawback of the magnet heating system 1014 is the use of an additional magnet tap 1022 (i.e. current lead), which causes additional thermal loading on the cryostat 803 and resistance loading on the capacitors 1016A, 1016B. The thermal load on the cryostat 803 may be reduced if the capacitors 1016A, 1016B are cryogenically cooled, thus allowing for a “cold” connection to the magnet 802 that remains “off” while the magnet 802 is in use and does not cause heat to be transferred from the magnet 802. However, the additional cooling required may in some cases be prohibitive as the capacitor bank may be large (for example, given the typical volumetric energy density of room-temperature oil-film capacitors, a 400 KJ capacitor bank would occupy around 2.7 m³).

FIG. 10 shows an HTS magnet system 1200 that is similar to the HTS magnet system 1000 of FIG. 8, except that the magnet heating system 1214 comprises two AC voltage sources 1214A, 1214B for driving AC current through each of the coil sections 804A, 804B. The large inductance of the spiral path of each of the coil sections 804A, 804B means that the current flows essentially radially through the coil sections 804A, 804B. The AC voltage sources 1214A, 1214B operate at the same frequency and are 180 degrees out of phase with one another, such that the voltage across the HTS magnet 802 remains approximately zero at all times. The use of AC current means that the coil sections 804A, 804B are neither discharged or charged while they are being heated, i.e.

the DC current flowing through the magnet 802 remains substantially constant, at least until a quench is induced in the magnet 802.

FIG. 11 shows an implementation of the magnet heating system 1214 comprising a transformer 1302 comprising a primary coil 1304 and two secondary coils 1314A, 1314B, which act as the AC voltage sources 1214A, 1214B to apply an AC voltage across each of the coil sections 804A, 804B. The transformer 1302 is driven by an inverter (not shown) that injects an AC current oscillating at a predefined frequency. The inverter may be constructed using insulated-gate bipolar transistor (IGBTs), for example. A capacitor (not shown) may be connected in series with the invertor to compensate for any reactive parasitic components in the transformer or lead inductances. The resonant frequency of the system may be around 12 kHz, for example, which may be tuned by adjusting the capacitance of the capacitor. Terminals of the secondary coils 1314A, 1314B (e.g. the respective negative terminals of the secondary coils) are connected together, to apply a common-mode voltage to the magnet tap 1220 provided between the first and second coil sections 804A, 804B. Scaling the system to include more coil sections 804A, 804B only requires additional secondary windings on the transformer 1302 and does not increase the number of active components.

The transformer 1302 is preferably placed inside the cryostat 803 and two current leads 1306A, 1306B are used for connecting to the inverter (although in some implementations the transformer 1302 may be outside the cryostat 803 instead). The size of the current leads 1306A, 1306B can be greatly reduced as the transformer primary current can be scaled down by increasing the turns ratio of the transformer 1302 (i.e. the number of turns of the secondary coils 1314A, 1314B divided by the number of turns of the primary coil 1304).

In the example shown in FIG. 11, the transformer 1302 is a single-phase transformer that operates at the switching frequency of the inverter. The power provided by the transformer 1302 pulsates at twice the switching frequency of the inverter, which means that the peak electric currents in the transformer 1302 are about twice as high as those produced by the DC discharge magnet heating systems 814, 1014 described above in connection with FIGS. 8 and 10. To reduce the peak currents, a 3-phase transformer can be used instead, where the phases of the currents are spaced by 120° and the instantaneous combined power remains constant, reducing the root mean square (RMS) current in the primary coils by roughly 43%.

FIG. 12 shows an HTS magnet system 1400 comprising an HTS magnet 1402 comprising six HTS field coils or coil sections 1404A-F connected in series, with a DC power supply 1410 connected across the coil sections 1404A-F to supply current to them for generating the desired magnetic field. Each of the coil sections 1404A-F has a corresponding AC power supply 1412A-F (forming part of magnet heating system 1414) for supplying AC current for heating the coil sections 1404A-F. The AC voltage sources 1412A-F corresponding to successive pairs of coil sections (i.e. coil sections 1404A-B, 1404C-D and 1404E-F) are configured such that the coil sections in each pair are out of phase with one another by 180 degrees, as described above for the transformer 1214 in FIG. 11.

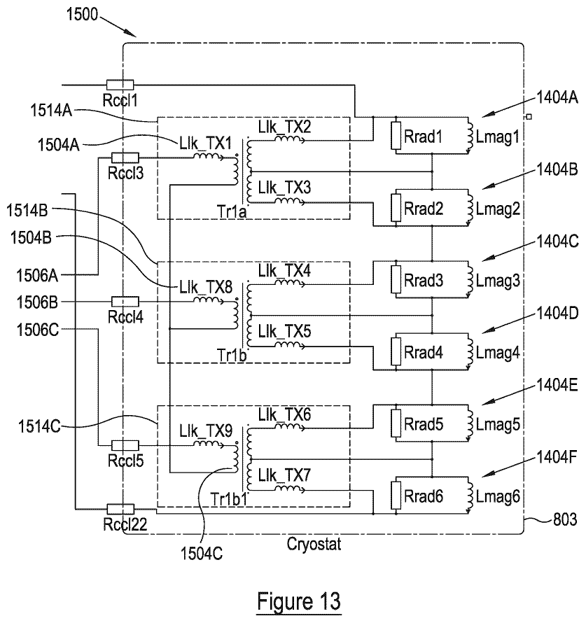

FIG. 13 shows an implementation 1500 of the HTS magnet system 1400 shown in FIG. 12, which includes three transformers 1514A-C having respective primary coils 1504A-C that are connected in a delta configuration (i.e. connected to one another in series to form a triangle), with each primary coil 1504A-C receiving AC current from one of three current leads 1506A-C, each current lead 1506A-C having an AC waveform that is 120 degrees out of phase with the AC waveforms of the two other current leads 1506A-C. The transformers 1514A-C are configured to form a balanced three phase system, so that the AC currents provided to the coil sections 1404A-F from the transformers 1514A-C are “balanced”, i.e. sum to zero. Therefore, the voltage across the HTS magnet 1402 as a whole remains zero (or less than a predefined value such as 100 V, 50 V, 10 V or even 1 V) whilst the coil sections 1404A-F are heated by the AC currents.

The transformers 1214, 1514A-C may be implemented in a number of ways: ferrous core, air-core, or a wireless power-transfer link, are all viable solutions, for example. In some implementations, the three transformers 1514A-C may be replaced by a single three-phase transformer. However, the use of separate transformers 1514A-C, may allow different voltages to be provided for each phase to achieve different heating strategies for the different coil sections 1404A-F.

Where the above examples have discussed applying voltages across coil sections of a field coil, more generally the voltages may be applied across coil sections spanning multiple field coils, or groups of multiple field coils connected in series or in parallel. For example, for a magnet comprising two field coils, a first coil section may span a first of the field coils and a second coil section may span the second of the field coils. In any case, the coil sections should preferably be substantially identical, e.g. sections of a pancake coil may be achieved by providing one or more taps such that there are an equal number of windings either side of the tap or between successive taps (or the number of windings may preferably be equal to within 20%, 10% or 5%, for example), or the HTS coils spanned by each coil section may contain the same number of equivalent coils connected in an equivalent manner, e.g. for an HTS magnet comprising fourteen HTS coils connected in series, each section may contain seven HTS coils connected in series. In one embodiment, two magnet taps may be used to divide a single HTS field coil into three (equal) sections and voltages from the secondary coils of a three-phase power supply applied across the respective sections. Configurations such as these mean that the magnitude of the voltage across the HTS magnet can be kept as low as possible. The HTS field coils are non-insulated or partially insulated so that they can be heated by radial current, i.e. current that flows through a conductive layer between the turns rather than along a spiral path.

The magnet heating systems 814, 1014, 1214, 1414 described above may be triggered in response to detection of a quench or conditions likely to lead to a quench, this detection may be by any practical method. For example:
detection of an excess voltage across the HTS material in the magnet;
the use of secondary HTS tapes which are provided adjacent to the HTS field coils, and configured to quench before the any of the HTS coils, e.g. as described in WO2017/042541 or WO2019/150091;
detection of temperature, strain, magnetic fields, or other conditions within the magnet coil, e.g. via Raleigh scattering in fibre optic cables as described in WO2018/078327 or via other temperature, strain, or magnetic field detectors as known in the art.

The magnet heating systems 814, 1014, 1214, 1414 described above may also be applicable to other situations where the magnet is ramped down, e.g. when shutting the magnet down under ordinary conditions, in the absence of any detected quench (or conditions likely to lead to a quench), or where heating of the magnet is required for any other purpose.

The above disclosure can be applied to a variety of HTS magnet systems. In addition to the tokamak plasma chamber mentioned above as an example, it may be used for HTS coils in nuclear magnetic resonance imaging (NMR/MRI) devices, manipulation of magnetic devices within a non-magnetic medium via magnetic fields (e.g. robotic magnetic navigation systems for manipulating medical devices within a patient), and magnets for electric motors, e.g. for electronic aircraft. As a further example, the disclosure may be applied to proton beam therapy devices comprising HTS magnet systems which include the disclosed features, where the HTS magnet systems are used within the accelerator of the PBT device, the quadrupole or dipole steering magnets of the PBT device, or any other magnet of the PBT device.

1. A superconductor magnet system comprising:
a field coil assembly comprising two or more coil sections connected in series, each coil section having a plurality of turns comprising superconductor material, the turns in each coil section being connected by an electrically conductive material such that electric current can be shared between the turns; and
a magnet heating system comprising a plurality of voltage sources, each of the voltage sources being connected across a respective one of the coil sections of the field coil assembly to apply a voltage having an AC component and/or a DC component across the coil section to drive current through the electrically conductive material, the voltage sources being configured such that at least two of the voltages have AC components that are out of phase and/or DC components that have opposing polarities.

2. A superconductor magnet system according to claim 1, wherein the voltage sources are configured such that a phasor sum of the voltages applied across the coil sections has an amplitude less than an amplitude of at least one of the voltages applied across the coil sections.

3. A superconductor magnet system according to claim 1, wherein the voltage sources are configured such that a phasor sum of the voltages applied across the coil sections has an amplitude less than an amplitude of each of the voltages applied across the coil sections.

4. A superconductor magnet system according to claim 1, wherein the voltage sources are configured such that respective amplitudes of the voltages applied across to the coil sections differ by less than 10% of the largest of the amplitudes.

5. A superconductor magnet system according to claim 1, wherein each voltage source comprises a capacitor or bank of capacitors.

6. A superconductor magnet system according to claim 1, wherein each of the voltage sources comprises a respective switch for connecting and/or disconnecting the voltage source from its respective one of the coil sections.

7. A superconductor magnet system according to claim 1 wherein the electrically conductive material comprises an electrically conductive layer separating the turns.

8. A superconductor magnet system according to claim 1, wherein the magnet heating system comprises a transformer having at least one primary coil for inducing respective AC voltages across two or more secondary coils of the transformer simultaneously, each of the voltage sources comprising at least one of the secondary coils connected across the corresponding coil section to drive current through the electrically conductive material, the transformer being configured such that the AC voltages applied across the coil sections are out of phase.

9. (canceled)

10. (canceled)

11. (canceled)

12. (canceled)

13. (canceled)

14. (canceled)

15. (canceled)

16. (canceled)

17. A superconductor magnet system according to claim 1, wherein each of the coil sections includes a respective number of turns, the numbers of turns being equal to within 10% of a largest of the numbers of turns.

18. A superconductor magnet system according to claim 1, wherein the field coil assembly comprises multiple field coils connected in series, each coil section being provided by a respective one or more of the field coils.

19. A superconductor magnet system according to claim 18, wherein each coil section comprises the same number of field coils.

20. A tokamak comprising one or more superconductor magnet systems according to claim 1.

21. (canceled)

22. A method of heating a superconductor magnet, the superconductor magnet comprising a field coil assembly comprising two or more coil sections connected in series, each coil section having a plurality of turns comprising superconductor material, the turns in each coil section being connected by an electrically conductive material such that electric current can be shared between the turns, the method comprising:
applying a respective voltage having an AC component and/or a DC component across each of the coil sections to drive current through the electrically conductive material, wherein at least two of the voltages have AC components that are out of phase and/or DC components that have opposing polarities.

23. A method according to claim 22, wherein the voltages are applied across the coil sections in response to detecting a quench or conditions likely to cause a quench in one or more of the coil sections.

24. (canceled)

25. A method according to claim 22, wherein applying a respective voltage having an AC component and/or a DC component across each of the coil sections to drive current through the electrically conductive material comprises:
applying an AC voltage to at least one primary coil of a transformer to induce respective AC voltages across two or more secondary coils of the transformer simultaneously; and
applying each of the AC voltages across a respective one of the coil sections, wherein the AC voltages applied across the coil sections are out of phase.

26. A method according to claim 22, further comprising connecting a power supply across the superconductor magnet to cause electric current to flow through the superconductor material to generate a magnetic field, the power supply remaining connected across the superconductor magnet after applying the respective voltages across each of coil sections, at least until the temperature of some or all of the superconductor material in the coil section exceeds a critical temperature of the superconductor material.

27. A superconductor magnet system comprising:
a magnet assembly comprising two or more coil sections connected in series, each coil section having a plurality of turns comprising superconductor material;
an alternative current path across each coil section, the alternative current path comprising resistive material and having a low inductance compared to the respective coil section such that a changing current across the coil section preferentially flows through the alternative current path, wherein heating of the resistive material caused by current flowing through the alternative current path causes heating of the superconductor material of the respective coil section; and
a plurality of voltage sources, each of the voltage sources being connected across a respective one of the coil sections and its alternative current path to apply a voltage having an AC component and/or a DC component, the voltage sources being configured such that at least two of the voltages have AC components that are out of phase and/or DC components that have opposing polarities.

28. A superconductor magnet system according to claim 27, wherein the field coil assembly comprises either:
multiple field coils connected in series, each coil section being provided by a respective one or more of the field coils; or
a single field coil, each coil section being provided by a subset of the turns of the field coil.

29. A superconductor magnet system according to claim 1, wherein the field coil assembly comprises a single field coil, each coil section being provided by a subset of the turns of the field coil.

30. A method according to claim 22, wherein the field coil assembly comprises either:
multiple field coils connected in series, each coil section being provided by a respective one or more of the field coils; or
a single field coil, each coil section being provided by a subset of the turns of the field coil.
